(19) United States
(12) Patent Application Publication
(10) Pub. No.: US 2026/0258861 A1
(43) Pub. Date: Sep. 3, 2026

(54) Method for Controlling a Hydraulic Assembly of a Motor Vehicle Transmission, Hydraulic Assembly, and Motor Vehicle Transmission

(71) Applicant: ZF Friedrichshafen AG, Friedrichshafen (DE)

(72) Inventors: Clemens Moser, Mittelberg (AT); Mario Hasel, Hergatz (DE)

(21) Appl. No.: 18/878,464

(22) PCT Filed: Jun. 19, 2023
(86) PCT No.: PCT/EP2023/066349

§ 371 Date: Dec. 23, 2024

(30) Foreign Application Priority Data
Jun. 28, 2022 (DE) 10 2022 206 479.8

(51) Int. Cl. F16H 61/30; F16H 63/24; F16H 63/30

(52) U.S. Cl. CPC F16H 61/30; F16H 63/24; F16H 63/3026; F16H 2200/0039; F16H 2200/2041

(57) ABSTRACT

A method for controlling a hydraulic assembly of a motor vehicle transmission includes engaging, in a first gear step of at least two different gear steps, at least three friction clutches of the hydraulic assembly. The method further includes engaging, in a second gear step of the at least two different gear steps, at least two of the friction clutches, at least one of the friction clutches engaged in the second gear step differing from each of the friction clutches engaged in the first gear step. For each of the at least two different gear steps, a maximum of one friction clutch is engaged using a system pressure of the hydrualic assembly, while each other engaged friction clutch is controlled in a closed loop at a respective engagement pressure using a respective pressure control valve of a plurality of pressure control valves of the hydraulic assembly.

### CROSS-REFERENCE TO RELATED APPLICATION

The present application is related and has right of priority to German Patent Application No. 10 2022 206 479.8 filed on Jun. 28, 2022 and is a nationalization of PCT/EP 2023/066349 filed in the European Patent Office on Jun. 19, 2023, both of which are incorporated by reference in their entirety for all purposes.

### FIELD OF THE INVENTION

The present invention relates generally to a method for controlling a hydraulic assembly of a motor vehicle transmission, which hydraulic assembly has a system pressure and includes a plurality of friction clutches which are actuated hydraulically by respective pressure control valves.

### BACKGROUND

Document DE 10 2006 010 676 A1 relates to a method for controlling the system pressure of an automatic transmission. A nominal system pressure is to result from the maximum selection below the minimum pressures which outside a shift of the engaged gear step are necessary for the case of a shift for the actual gear step, the target gear step, and the shift pressure, and for carrying out further activated transmission functions inside and outside of shifts in order to ensure the reproducibility and/or the functional reliability of these functions.

For example, in an engaged gear step, the minimum pressure is ascertained on the basis of the pressure demand for ensuring the power transmission capacity of the shift element with the lowest power transmission capacity depending on the input torque and on the rotational speed, wherein, depending on the transmission oil temperature, an offset is added to the minimum pressure. If a plurality of friction clutches are present in a motor vehicle transmission, it is possible to engage these friction clutches in two different ways. According to one possibility, an associated pressure control valve is used to actuate the friction clutch at a transmission torque that corresponds to an engaged state of the friction clutch. This clutch actuation pressure is generally lower than a system pressure of the hydraulic assembly. The pressure control valves used for this purpose are generally pressure reducing valves.

Generally, there is a certain hydraulic fluid capacity (“volume”) between the pressure control valve and the associated actuating device for the friction clutch. In the above-described type of closed-loop control of the clutch pressure at an engagement pressure which is controlled in a closed loop, the amount of hydraulic fluid within this hydraulic fluid capacity re-mains nearly constant.

The second possibility for actuating the friction clutch consists of connecting-through the associated pressure control valve, i.e., bringing this into a state in which a valve inlet is directly connected to a valve outlet, such that the clutch actuation pressure is equal to the system pressure.

Such a hydraulic capacity has a damping effect and stabilizes the system pressure. Intermittently occurring pressure drops are compensated for by the hydraulic fluid stored in the hydraulic fluid capacity of this clutch. In addition, the stored hydraulic capacity prevents the system pressure control valve from swinging open.

The connecting-through of a pressure control valve that is associated with a friction clutch also has the advantage that the activation is considerably simplified.

Therefore, of a plurality of friction clutches that are to be engaged in a gear step, a predominant number of the friction clutches are connected through. In particular, of three clutches to be engaged, typically two are connected through. The third friction clutch is adjusted to an engagement pressure, which is controlled in a closed loop, by the associated pressure control valve. This clutch, which is adjusted to the engagement pressure, which is controlled in a closed loop, is generally that friction clutch which generally requires the highest pressure of the three friction clutches in order to establish the engaged state. This is, there-fore, the “weakest” of the friction clutches.

The engagement pressure required to engage a friction clutch is dependent on a plurality of variables such as the diameter of the friction clutch, the surface area of the disks, the number of the disks, the torque to be transmitted at a specifically engaged gear step, etc.

The control of such hydraulic assemblies is extraordinarily complex. In many cases, de-spite the aforementioned measures, losses in shift quality arise in many operating states due to the lack of reproducibility of filling hydraulic fluid capacities.

### SUMMARY OF THE INVENTION

Against this background, an improved method for controlling a hydraulic assembly of a motor vehicle transmission, a hydraulic assembly for such a motor vehicle transmission, and a motor vehicle transmission as such, are provided which provide a high shift quality.

A method for controlling a hydraulic assembly of a motor vehicle transmission, which hydraulic assembly has a system pressure and includes a plurality of friction clutches which are actuatable hydraulically by respective pressure control valves, is provided wherein at least two different gear steps are configured. In one gear step of the gear steps, at least three of the friction clutches are engaged, and in another gear step of the gear steps, at least two of the friction clutches are engaged, at least one of which differs from the three friction clutches that are engaged in the one gear step. In each of the two different gear steps, a maximum of one friction clutch of the respective engaged friction clutches is engaged, in that this friction clutch is actuated using the system pressure, and the other friction clutch(es) is/are regulated to a respective engagement pressure using the associated pressure control valve(s) thereof.

Moreover, a hydraulic assembly for a motor vehicle transmission is provided, which hydraulic assembly has a control device which carries out the aforementioned method.

Finally, a motor vehicle transmission having such a hydraulic assembly is provided.

In at least two different gear steps, which are configured by the motor vehicle transmission, a respective set or a respective subset of the available friction clutches of the hydraulic assembly is actuated, such that the friction clutch is engaged.

“Engaged” means in the present case that the friction clutch is capable of transmitting a maximum torque that is applied at the input thereof in an essentially slip-free manner.

Of the plurality of friction clutches that are to be engaged in order to engage a gear step, a maximum of one friction clutch is engaged by connecting through the associated pressure control valve. As a result, a certain damping effect on the system pressure is still achievable.

In the prior art, of such a plurality of friction clutches, at least two friction clutches are engaged in a gear step by connecting through the pressure control valves thereof.

During the engaged state, the hydraulic assembly must then cover, using the pump system thereof, not only the volumetric flow demand of an additional clutch to be engaged, but also the hydraulic capacity of the clutches which have been connected through to system pressure.

This additional volumetric flow demand of the connected-through clutches is very high and may not be covered in critical oil supply states. In order to avoid an insufficient supply, a rapid filling must therefore be carried out using a reduced rapid filling pressure. This results in poorer spontaneity.

Depending on the clutch size of the connected-through clutches in the prior art, the additional volumetric flow demand can also be so great that it is no longer sufficient to carry out a reduced rapid filling, and an insufficient supply having strong system pressure drops results. This can occur above all during gear changes in which an input rotational speed of a pump assembly is low, such as in a start-stop situation or during sailing with the motor switched off. In such cases, the reproducibility of the clutch fillings can suffer significantly, which can result in losses in shift quality.

Due to the measure of connecting through a maximum of one of the clutches to be engaged, and controlling, in a closed loop, the other friction clutches which are to be engaged in a gear step at the respective engagement pressure thereof, specifically by the associated pressure control valves, the aforementioned disadvantages of the prior art are avoided.

In other words, due to the introduction of an optimized logic for supplying hydraulic fluid, either only one or none (for example, in the neutral planes) of the friction clutches to be engaged is/are connected-through.

An additional advantage therefore results in the shutdown behavior of the friction clutch. The connecting-through of the friction clutch results in a decelerated shutdown behavior because the valve must move from the end stop back onto the control edge. This is avoided in many cases using the present invention.

The motor vehicle transmission is any type of motor vehicle transmission such as an automated manual transmission, a dual-clutch transmission, etc. Preferably, the motor vehicle transmission is an automatic transmission with a planetary design.

A friction clutch generally refers to a non-positively engaging clutch, i.e., for example, a multi-disk clutch.

The particular engagement pressure to which a friction clutch is controlled in a closed loop by the associated pressure control valve is a function of the friction clutch itself (number of disks, surface area of the disks, disk material, etc.), and, optionally, is a function of a gear step-dependent supporting factor.

In the present case, in order to simplify the representation with respect to a friction clutch, the pressure control valve of which is connected through, reference is also made to a “connected-through friction clutch.” It is also understood that the “clutch pressure” is a hydraulic pressure in an actuating device of the friction clutch, i.e., for example, the pressure in a hydraulic cylinder, by which disk packs are pressed against one another.

According to one preferred embodiment of the method, none of the friction clutches engaged in a gear step are actuated using the system pressure when a hydraulic fluid supply parameter drops below a predefined threshold value.

As a result, the above-described problem is solved in an even better way, since system pressure drops are avoided with greater likelihood.

Furthermore, it is preferred when the hydraulic fluid supply parameter is a function of a supply variable of a pump assembly.

The pump assembly is an individual pump, which is driven by an individual shaft. The pump assembly can be a more complex pump assembly, however, in which a pump is drivable in various ways. A pump assembly can also include two or more pumps, which have different flow rates, for example, given the same rotational speed.

A supply variable can therefore be set by this pump assembly, i.e., also, for example, when the one pump or the other pump of a multi-pump assembly is activated. The supply variable can also be a function, however, of how the pump assembly is driven (for example, by an internal combustion engine or by an electric motor).

It is particularly preferred when the supply variable of the pump assembly is a rotational speed of the pump assembly.

In a multi-pump assembly, the rotational speed of the pump assembly is the rotational speed of the pump having the higher flow rate.

Overall, it is also preferred when the hydraulic assembly is carries out a rapid filling in order to engage a friction clutch.

The hydraulic fluid capacity is variable due to the actuating device of the friction clutch. A friction clutch typically has a characteristic curve in which, starting from an actuating pressure of 0 bar, a certain clearance of the friction clutch (clearance from a disk pack) must first be overcome before a hydraulic pressure in the actuating device correlates with the torque that is transmittable by the friction clutch.

The hydraulic fluid volume necessary for overcoming the clearance is to be achieved rap-idly, of course, for rapid gear changes. This can take place, in particular, in that, during a rapid filling, initially a comparatively high volumetric flow is conveyed towards the actuating device of the friction clutch until the clearance is overcome. The hydraulic pressure used for this purpose is relatively low. In this phase, a decisive factor is a rapid filling of the hydraulic volume between the pressure control valve and the actuating device.

As soon as the clearance has been overcome, even a small change in volume results in an increase in pressure, such that, in the subsequent adjustment phase of the friction clutch, only a smaller volumetric flow is to be supplied in order to actuate and finally engage the friction clutch.

In order to increase the volumetric flow, it is possible to activate a pump with a high delivery rate.

It is particularly preferred when the system pressure is raised for the rapid filling.

Due to the increased system pressure, a greater volumetric flow to the actuating device is generated.

The system pressure is increased, for example, by an electric motor-operated auxiliary drive of a system pressure pump (by increasing the rotational speed of the pump).

Overall, it is also advantageous when the hydraulic assembly has a pump assembly for generating the system pressure, wherein the pump assembly is driven by a power take-off of an internal combustion engine and/or by an electric motor.

The drive by the internal combustion engine can take place comparatively efficiently. In phases in which the rotational speed of the internal combustion engine is low (idle running) or 0 (start/stop), the electric motor is used to drive the pump assembly.

In preferred embodiments, the electric motor can be the only drive motor for the pump assembly. Furthermore, an electric motor in many embodiments can enable a type of boost mode in which drive powers of the internal combustion engine and of the electric motor are added together in order to increase the rotational speed of the pump assembly.

Furthermore, it is advantageous overall when at least one of the friction clutches is a clutch or a brake of an automatic transmission with a planetary design.

A clutch is used in general to connect two generally rotatable elements of such an automatic transmission. A brake is used to fix a rotatable element of the automatic transmission with respect to a housing.

Furthermore, it is advantageous overall when the system pressure of the hydraulic assembly is controlled in a closed loop by at least one adjustable system pressure control valve.

An increase in the system pressure can in many cases therefore be carried out due to a combination of the increase in the rotational speed and due to an adjustment of the system pressure control valve.

It is understood that the features, which are mentioned above and which will be described in greater detail in the following, are usable not only in the particular combination indicated, but rather also in other combinations or alone, without departing from the scope of the present invention.

### BRIEF DESCRIPTION OF THE DRAWINGS

Exemplary embodiments of the invention are represented in the drawing and are explained in greater detail in the following description. Wherein:

FIG. 1 shows, in schematic form, a hydraulic assembly of a motor vehicle transmission for a motor vehicle;

FIG. 2 shows a schematic characteristic curve of a pressure in an actuating device over a manipulated variable;

FIG. 3 shows a gear shift matrix for three gear steps and four friction clutches used in the process; and

FIG. 4 shows diagrams of volumetric flows to the actuating devices of the four friction clutches during a gear change from gear step 1 toward gear step 2 as shown in FIG. 3.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

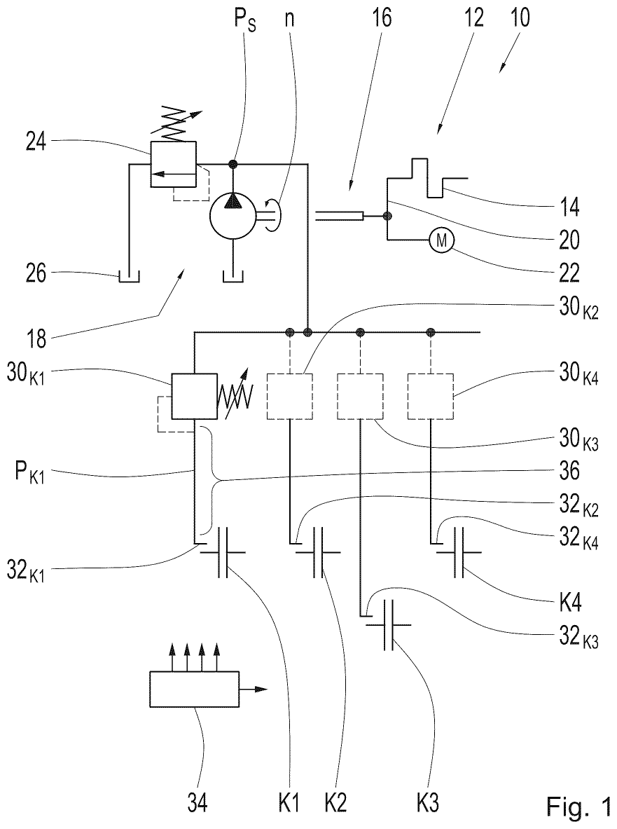

In FIG. 1, a motor vehicle 10 is shown in schematic form. The motor vehicle 10 includes a motor vehicle transmission 12, in particular an automatic transmission with a planetary design.

The motor vehicle 10 also includes an internal combustion engine 14.

The motor vehicle transmission 12 includes a hydraulic assembly 16. The hydraulic assembly 16 has a pump assembly 18. The pump assembly 18 is drivable at a particular rotational speed n by a power take-off 20 of the internal combustion engine 14 and by an electric motor 22, which is connected in parallel to the internal combustion engine 14.

A pressure port of a pump of the pump assembly 16 is connected to a tank 26 via a system pressure control valve 24. A suction connection of the pump is also connected to the tank 26.

The motor vehicle transmission 12 has a plurality of friction clutches, including a first friction clutch K1, a second friction clutch K2, a third friction clutch K3, and a fourth friction clutch K4.

The number of four friction clutches is merely an example. The motor vehicle transmission 12 can have fewer than four friction clutches and can have more than four friction clutches, for example, five, six, seven, eight, or nine friction clutches.

The motor vehicle transmission configures a plurality of gear steps. In order to configure each of the gear steps, a subset of the available friction clutches is actuated.

The friction clutches K1, K2, K3, K4 fix, for example, elements of planetary gear sets to one another or fix elements of planetary gear sets with respect to a housing.

The general configuration of automatic transmissions with a planetary design is known. Gear steps are configured therein by disengaging and engaging shift elements as friction clutches.

Each of the friction clutches K1, K2, K3, K4 is assigned a respective pressure control valve 30 (e.g., pressure control valve 30K1, pressure control valve 30K2, pressure control valve 30K3, pressure control valve 30K4). The pressure control valves 30K1, 30K2, 30K3, 30K4 are each pressure reducing valves, which are controllable in a closed loop and are activated by a control device 34. The pump assembly 16 is also activated by the control device 34.

Each of the clutches K1, K2, K3, K4 is also associated with a respective actuating device 32 (e.g., actuating device 32K1, actuating device 32K2, actuating device 32K3, actuating device 32K4), which is, for example, a hydraulic cylinder.

The actuating device 32K1 associated with the first clutch K1 is connected to an outlet of the pressure control valve 30K1.

A hydraulic fluid volume between each of the pressure control valves 30 and the associated actuating device 32 (including the volume of the actuating device 32) is also referred to as the hydraulic fluid capacity 36.

The further clutches K2, K3, K4 are similarly associated with respective actuating devices 32K2, 32K3, 32K4, which are connected to respective pressure control valves 30K2, 30K3, 30K4.

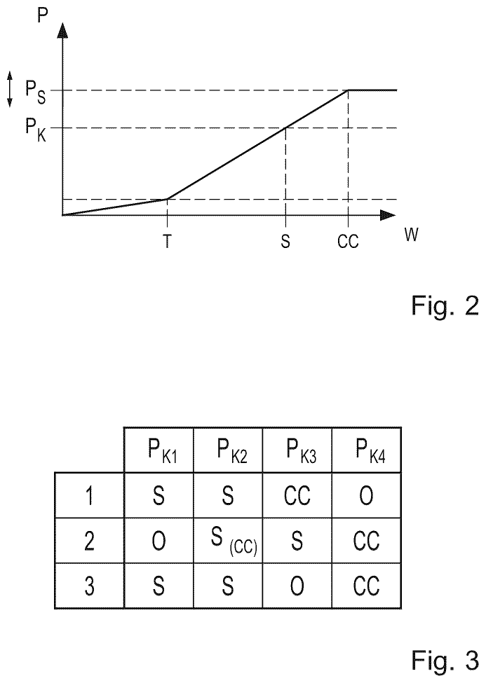

FIG. 2 shows a schematic diagram of pressure P over manipulated variable W for a pressure control valve 30. The diagram is purely schematic and the proportions are likely not to scale.

In order to close a pressure control valve, the manipulated variable W is increased. This is carried out, for example, by sliding a valve slide in a valve, or the like.

As a result, the pressure P in the actuating device 32 gradually increases, although with a relatively low slope, until a value T of the manipulated variable W is reached. The value T of the manipulated variable corresponds to a “touch point” at which a clearance of the friction clutch has been overcome and every additional increase in the pressure in the actuating device 32 results in an increase in the torque that must be transmitted by the friction clutch.

As the manipulated variable W continues to increase, a manipulated variable S for a controlled engagement pressure is finally reached, at which a clutch actuation pressure PK is configured, and at which the associated friction clutch is engaged. “Engaged” means in this context that, depending on general conditions such as engaged gear step, the friction clutch itself, etc., it is ensured that a maximum torque applied at the input of the friction clutch is transmittable essentially in a slip-free manner to the output of the friction clutch.

The control device 34 controls the manipulated variable S in a closed loop such that the desired clutch actuation pressure PK is maintained, i.e., controlled in a closed loop.

The clutch actuation pressure PK is generally lower than the system pressure PS. The system pressure PS must be selected in any case to be higher than the highest clutch actuation pressure PK of all friction clutches engaged in a particular transmission state.

If the manipulated variable W is increased above the value S, a manipulated variable CC for an engagement pressure at the system pressure level is finally reached. The manipulated variable CC corresponds to the system pressure PS. The manipulated variable CC (“capacity control”) results in the associated pressure control valve 30 being connected through (in the present terminology, i.e., the associated friction clutch is connected through).

The pressure control valve is moved against a stop and no longer needs to perform a closed-loop control function. The hydraulic volume from a pump to a pressure control valve and the volume from a pressure control valve to an actuating device are directly interconnected. The result thereof is a damping effect on the overall hydraulic volume.

FIG. 3 shows a gear shift matrix of, for example, three gear steps, including a first gear step 1, a second gear step 2, and a third gear step 3, which are engageable by the motor vehicle transmission 12. The number of gear steps has been selected merely as an example.

The motor vehicle transmission can have fewer than three gear steps, although it can also have more than three gear steps, for example, four, five, six, seven, eight, or nine gear steps.

Generally, the number of friction clutches in the motor vehicle transmission increases when the number of gear steps increases.

Furthermore, manipulated variables are entered in the gear shift matrix shown in FIG. 3 for the clutch actuating pressures PK1, PK2, PK3, PK4 of the four friction clutches K1, K2, K3, K4.

In the gear step 1, the clutches K1, K2 are controlled in a closed-loop with respect to the engagement pressure thereof (manipulated variable S). The clutch K4 is engaged (manipulated variable 0). The clutch K3 is connected through (manipulated variable CC for the engagement pressure PK3 at the system pressure level).

In the gear step 2, the manipulated variable for the clutch K1 is 0. The manipulated variable for the clutch K3 is S. The manipulated variable for the clutch K4 is CC.

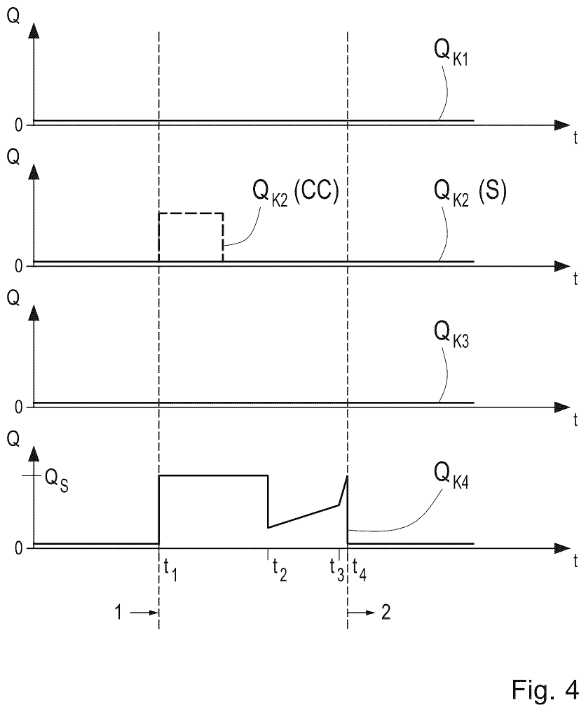

For the clutch K2, the manipulated variable is S. In the gear shift matrix shown in FIG. 3, the manipulated variable CC is entered in parentheses, however, which would have been set, for example, in the prior art. This is explained in greater detail below with reference to FIG. 4.

In the gear step 3, the manipulated variables for the clutches K1, K2 are both S. The manipulated variable for the clutch K3 is 0. The manipulated variable for the clutch K4 is CC.

It is apparent that at least three of the four friction clutches are engaged in all gear steps. Alternatively, only two friction clutches could be engaged in one gear step.

Different subsets of the friction clutches are engaged in each of the three gear steps. In other words, in one gear step of the gear steps, at least three of the friction clutches are engaged and in another gear step of the gear steps, at least two of the friction clutches are engaged, at least one of which differs from the three friction clutches that are engaged in the one gear step.

Furthermore, is it apparent in FIG. 3 that, in each of the different gear steps, a maximum of one friction clutch of the respective engaged friction clutches is engaged, in that this friction clutch is actuated using the system pressure (manipulated variable CC). The other friction clutches, which are engaged in the respective gear step, are controlled in a closed loop, however, at a respective engagement pressure (manipulated variable S) using the associated pressure control valves thereof.

FIG. 4 shows four diagrams of volumetric flows Q, which flow during a gear change from gear step 1 to gear step 2. Solid lines represent the volumetric flows QK1, QK2 (S), QK3, QK4 in the respective diagrams.

the diagrams shown in FIG. 4 each show the volumetric flow over time.

At a point in time t₁, a shift request into the gear step 2 takes place.

For the friction clutch K1, the pressure control valve is opened when the manipulated variable S is reached. Consequently, a volumetric flow to the actuating device 32K1 does not result.

For the friction clutch K3, a transition takes place from the manipulated variable CC to the manipulated variable S. In this case as well, an additional volumetric flow into the associated actuating device 32K3 does not take place.

For the friction clutch K2, the manipulated variable remains at “S”, such that an additional volumetric flow also does not flow into the associated actuating device 32K2.

The fourth friction clutch K4, however, is moved from the manipulated variable 0 to the manipulated variable CC.

In FIG. 4, it is apparent that, for this purpose, initially a rapid filling takes place from the period of time t₁ to a period of time t₂. In other words, a very high volumetric flow QS is set, for example, the volumetric flow QS is in a range of four liters per minute to ten liters per minute, in particular six liters per minute to eight liters per minute.

The point in time t₂ essentially corresponds to reaching the above-described “touch point”. At this point in time, the volumetric flow QK4 is initially sharply lowered again in order to then gradually increase up to the point in time t₃. Shortly before the final state is reached, at which the manipulated variable CC is reached, the volumetric flow is increased again with a higher gradient, specifically up to the point in time t₄. At this point in time, the manipulated variable CC for the fourth friction clutch K4 is adjusted and the volumetric flow drops back to 0. The gear change has been carried out.

As described above, only one volumetric flow is required for the fourth friction clutch K4 in this gear change.

In the prior art, generally at least two friction clutches are adjusted to the manipulated variable CC in every gear step state. This is shown schematically in FIG. 3 using “(CC)” for the gear step 2 for PK2.

In the prior art, it would have then become necessary, in the same gear change that has been described with reference to FIG. 4, to provide at the point in time t₁ not only a volumetric flow for the fourth friction clutch K4, but to additionally provide a volumetric flow QK2 (CC), which is shown as a dashed line in FIG. 4. This volumetric flow QK2 would have become necessary, starting from the state of the pressure control valve 30K2, in which the engagement pressure is controlled in a closed loop at manipulated variable S, in order to adjust the engagement pressure to the manipulated variable CC, i.e., by connecting through the pressure control valve 30K2. As a result, in the prior art, a higher volume would have been required to fill into the hydraulic fluid capacity 36 until the steady state (connected-through state) was reached.

This additional volumetric flow QK2 (CC), which is shown in FIG. 4, is not necessary in the present invention. Therefore, the situation is avoided in which, in critical oil supply states, the volumetric flow demand for the clutch K4 actually to be engaged cannot be covered, i.e., requiring a rapid filling to be carried out using a reduced rapid filling pressure. Since this volumetric flow QK2 (CC) is not necessary, improved spontaneity is achieved.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### Reference Characters

10 motor vehicle
12 motor vehicle transmission
14 internal combustion engine
16 hydraulic assembly
18 pump assembly
20 power take-off 14
22 electric motor
24 system pressure control valve
26 tank
30Kx pressure control valves
32Kx actuating devices (hydraulic cylinders)
34 control device
36 hydraulic fluid capacity
K1-K4 friction clutches
n rotational speed 18
P pressure
W manipulated variable
PS system pressure
PKx clutch actuation pressure
T touch point
S manipulated variable for regulated engagement pressure
CC manipulated variable for engagement pressure at the system pressure level (“capacity control”)
Q volumetric flow
QKx volumetric flow in the actuating device from the friction clutch
1-3 gear steps

1.-cm 11. (canceled)

12. A method for controlling a hydraulic assembly (16) of a motor vehicle transmission (12), the hydraulic assembly having a system pressure (PS) and including a plurality of friction clutches (K1, K2, K3, K4) and a plurality of pressure control valves (30), each of the plurality of friction clutches (K1, K2, K3, K4) being hydraulically actuatable by a respective one of the plurality of pressure control valves (30), the method including:
engaging, in a first gear step of at least two different gear steps (1, 2, 3), at least three of the plurality of friction clutches (K1, K2, K3, K4); and
engaging, in a second gear step of the at least two different gear steps (1, 2, 3), at least two of the plurality of friction clutches (K1, K2, K3, K4), at least one of the at least two of the plurality of friction clutches engaged in the second gear step differing from each of the at least three of the plurality of friction clutches (K1, K2, K3, K4) engaged in the first gear step,
wherein, for each of the at least two different gear steps, a maximum of one friction clutch (K1, K2, K3, K4) of engaged friction clutches of the plurality of friction clutches (K1, K2, K3, K4) is engaged using the system pressure (PS) and each other friction clutch (K1, K2, K3, K4) of the engaged friction clutches is controlled in a closed loop at a respective engagement pressure (PK) using the respective pressure control valve (30) of the plurality of pressure control valves (30).

13. The method of claim 12, wherein, for each of the at least two different gear steps, none of the engaged friction clutches (K1, K2, K3, K4) is actuated using the system pressure (PS) when a hydraulic fluid supply parameter drops below a predefined threshold value.

14. The method of claim 13, wherein the hydraulic fluid supply parameter is a function of a supply variable of a pump assembly (18).

15. The method of claim 14, wherein the supply variable of the pump assembly (18) is a rotational speed (n) of the pump assembly (18).

16. The method of claim 12, wherein the hydraulic assembly (16) carries out a rapid filling in order to engage the one friction clutch (K1, K2, K3, K4).

17. The method of claim 16, wherein the system pressure (PS) is raised for the rapid filling.

18. The method of claim 12, wherein the hydraulic assembly (16) has a pump assembly (18) for generating the system pressure (PS), the method further comprising driving the pump assembly (18) by one or both of a power take-off (20) of an internal combustion engine (14) or an electric motor (22).

19. The method of claim 12, wherein at least one of the plurality of friction clutches (RK) is a clutch or a brake of a planetary automatic transmission (12).

20. The method of claim 12, further comprising regulating the system pressure (PS) of the hydraulic assembly (18) by adjusting at least one adjustable system pressure control valve (24).

21. A hydraulic assembly for a motor vehicle transmission, comprising a control device (34) configured to perform the method of claim 12.

22. A motor vehicle transmission (12), comprising the hydraulic assembly (18) of claim 21.
